(19) United States
(12) Patent Application Publication
(10) Pub. No.: US 2023/0097950 A1
(43) Pub. Date: Mar. 30, 2023

(54) DETERMINING A CURRENT FOCUS AREA OF A CAMERA IMAGE ON THE BASIS OF THE POSITION OF THE VEHICLE CAMERA ON THE VEHICLE AND ON THE BASIS OF A CURRENT MOTION PARAMETER

(71) Applicant: Valeo Schalter und Sensoren GmbH, Bietigheim-Bissingen (DE)

(72) Inventors: Fabian Burger, Bobigny (FR); Jonathan Horgan, Tuam, County Galway (IE); Philippe Lafon, Bobigny (FR)

(73) Assignee: Valeo Schalter und Sensoren GmbH, Bietigheim-Bissingen (DE)

(21) Appl. No.: 17/911,020

(22) PCT Filed: Mar. 9, 2021
(86) PCT No.: PCT/EP2021/055847

§ 371 Date: Sep. 12, 2022

(30) Foreign Application Priority Data
Mar. 13, 2020 (DE) 10 2020 106 967.7

(51) Int. Cl. B60R 11/04; H04N 5/232; G06T 7/70; G06T 7/20

(52) U.S. Cl. CPC B60R 11/04; H04N 5/23245; G06T 7/70; G06T 7/20; G06T 2207/30252

(57) ABSTRACT

The invention relates to a method for providing an environment image (36) on the basis of a camera image (30) of a vehicle camera (14, 16, 18, 20) of a vehicle (10) for monitoring an environment (28) of the vehicle (10), the camera image (30) comprising a camera image area having a camera resolution, for further processing, in particular by means of a driving assistance system of the vehicle (10), the method comprising the steps of: ascertaining a position of the vehicle camera (14, 16, 18, 20) on the vehicle (10), capturing at least one current motion parameter (44) of the vehicle (10), determining a current focus area (32) within the camera image (30) on the basis of the position of the vehicle camera (14, 16, 18, 20) on the vehicle (10) and on the basis of the at least one current motion parameter (44), and transferring pixels of the camera image (30) into the environment image (36), pixels from the current focus area (32) being transferred, with a first resolution, into a first image area (40) of the environment image (36) which corresponds to the current focus area (32), and pixels of the camera image (30) from a remaining area (34) which does not lie in the current focus area (32) being transferred, with a second resolution, into a second image area (42) of the environment image (36) which corresponds to said remaining area, the second resolution being less than the first resolution. The invention further relates to an image unit (12) for providing an environment image using the method above and to a driving assistance system comprising at least one image unit (12) of this type.

The present invention relates to a method for providing an environment image on the basis of a camera image from a vehicle camera of a vehicle for monitoring an environment of the vehicle, the camera image having a camera image area with a camera resolution, for further processing, in particular by a driving assistance system of the vehicle.

The present invention also relates to an image unit for providing an environment image on the basis of a camera image from a vehicle camera of a vehicle for monitoring an environment of the vehicle, for further processing, in particular by a driving assistance system of the vehicle, comprising at least one vehicle camera for providing the camera image having a camera image area and a camera resolution, and a control unit which is connected to the at least one vehicle camera via a data bus and receives the respective camera image via the data bus, wherein the image unit is designed to carry out the above method for providing an environment image for the at least one vehicle camera.

Furthermore, the present invention relates to a driving assistance system for a vehicle for providing at least one driving assistance function based on monitoring an environment of the vehicle, which comprises at least one image unit above.

In the automotive sector, capturing the environment of vehicles using cameras attached to the vehicle, hereinafter vehicle cameras, is widespread in order to implement different driving assistance functions, some of which are referred to as ADAS (Advanced Driver Assistance Systems). The same applies to autonomous driving which also requires complete awareness of the vehicle's environment. Wide-angle cameras or even fish-eye cameras are often used in order to be able to completely capture the vehicle's environment using a small number of vehicle cameras, with the result that angular ranges of more than 160° up to 180° and sometimes even more can be captured using the vehicle cameras. Based on camera images recorded with the vehicle cameras, for example, an optical flow can be determined and vehicle or pedestrian detection or lane detection can be carried out. In addition to such tasks in the field of object detection, tasks in the field of segmenting image information are also known. The corresponding camera image can be processed, for example, by means of a computer vision algorithm and/or by means of deep neural network learning methods (deep learning), for example by means of a convolutional neural network (CNN). These evaluation algorithms are executed in particular on specially embedded platforms or on so-called digital signal processors (DSP) with a limited computing capacity.

A plurality of such vehicle cameras are often arranged on the vehicle, for example in a front area, in a rear area and in both side areas of the vehicle, in which case an evaluation of camera images from this plurality of vehicle cameras must then be carried out, in particular simultaneously, and provides a considerable amount of data for processing. Due in particular to the limited computing capacity, this can lead to time delays when processing the camera images and requires the provision of high computing power in the vehicle, which is associated with high costs.

Especially when using fish-eye cameras, distortions can occur that make it difficult to process the image. In particular, there is distortion in vertical lines and nearby objects are enlarged. In particular, these fish-eye images are corrected and straightened so that, for example, the computer vision algorithm can easily evaluate the corrected image.

In order to save computing time, it is known that the entire camera image is not evaluated. Different strategies which in particular evaluate a so-called region of interest (ROI) of the camera image accordingly are known from the prior art. In the prior art, therefore, only a sub-area of the camera image, in which in particular the important parts for further evaluation are located, is processed. Other image areas are therefore not evaluated any further. This is disadvantageous because some relevant information from the camera image cannot be captured, in particular relating to objects in the vicinity of the vehicle camera.

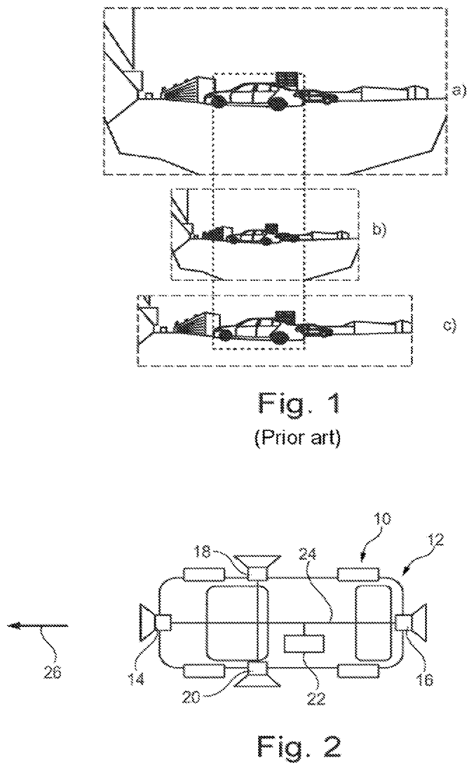

In addition, various approaches are known for reducing image information in order to increase the processing speed without requiring additional computing power. In principle, two different approaches are known for this and are illustrated in FIG. 1. Starting from a camera image or original image that is illustrated in FIG. 1 a) and has full resolution, linear downscaling can be carried out, for example, as illustrated in FIG. 1 b). Downscaling relates to a reduction in image information, for example by combining a plurality of pixels of the camera image into one pixel of an environment image for further processing. In linear downscaling, all pixels are scaled in the same way in order to generate the environment image in a reduced resolution. However, image information is lost in the process, with the result that in particular objects at a greater distance from the vehicle can no longer be reliably detected. An improved approach is to perform non-linear downscaling, as illustrated in FIG. 1 c). In non-linear downscaling, different regions of the camera image are scaled in different ways. As a result, high resolutions can be provided in certain areas of the environment image formed on the basis of the camera image, for example in the horizon area, whereas the resolution can be reduced in other areas, in particular in nearby areas of the environment of the vehicle. As a result, distant objects can also be reliably detected in the high-resolution area without losing relevant image information relating to the immediate area, as can occur, for example, when image information is cut off. Objects in the immediate area of the vehicle can also be reliably detected with a lower resolution due to their size. It is also advantageous that it is possible to use overall high compression rates, i.e. the environment images have a smaller number of pixels than the camera images provided by the vehicle cameras. Possible distortions in the environment image, in particular at edges of the image, are a disadvantage of the non-linear image processing.

Proceeding from the prior art mentioned above, the invention is therefore based on the object of specifying a method for providing an environment image on the basis of a camera image from a vehicle camera of a vehicle for monitoring an environment of the vehicle, the camera image having a camera image area with a camera resolution, for further processing, in particular by a driving assistance system of the vehicle, an image unit for carrying out the method and a driving assistance system having at least one image unit of this type, which make it possible to efficiently and reliably monitor the environment of the vehicle.

The object is achieved according to the invention by the features of the independent claims. Advantageous configurations of the invention are specified in the dependent claims.

The invention therefore specifies a method for providing an environment image on the basis of a camera image from a vehicle camera of a vehicle for monitoring an environment of the vehicle, the camera image having a camera image area with a camera resolution, for further processing, in particular by a driving assistance system of the vehicle, comprising the steps of determining a position of the vehicle camera on the vehicle, capturing at least one current motion parameter of the vehicle, determining a current focus area within the camera image on the basis of the position of the vehicle camera on the vehicle and the at least one current motion parameter, and transferring pixels of the camera image into the environment image, wherein pixels from the current focus area are transferred with a first resolution into a first image area of the environment image that corresponds to the current focus area, and pixels of the camera image from a remaining area that is not in the current focus area are transferred with a second resolution into a second image area of the environment image corresponding thereto, wherein the second resolution is lower than the first resolution.

The invention also specifies an image unit for providing an environment image on the basis of a camera image from a vehicle camera of a vehicle for monitoring an environment of the vehicle, for further processing, in particular by a driving assistance system of the vehicle, comprising at least one vehicle camera for providing the camera image having a camera image area and a camera resolution, and a control unit which is connected to the at least one vehicle camera via a data bus and receives the respective camera image via the data bus, wherein the image unit is designed to carry out the above method for providing an environment image for the at least one vehicle camera.

The invention furthermore specifies a driving assistance system for a vehicle for providing at least one driving assistance function based on monitoring an environment of the vehicle. The driving assistance system comprises at least one image unit above.

The basic idea of the present invention is therefore to dynamically adapt the focus area of the camera image in order to thus provide the environment image in an optimal form in each case for the respective driving situation depending on the at least one motion parameter. As a result, scaling can be dynamically adapted when the environment image is provided, in order to make it possible to efficiently process the environment image. In particular, the scaling is dynamically dependent on the respective current focus area within the environment image. Determining the current focus area in each case makes it possible to ensure that an optimum resolution is used in the environment image, with the result that a total amount of data to be processed is small and relevant information for different driving situations depending on the at least one motion parameter is retained due to the higher resolution in the first image area corresponding to the current focus area. As a result, the provision of the environment image is improved overall, since it is possible to avoid excessive resolutions of the environment image in areas that are not of interest based on the current driving situation. Each environment image does not have to cover all possible driving situations at the same time, but only one current driving situation based on the current motion parameter. This facilitates subsequent processing of the environment image, for example in order to detect and classify objects, so that less computing power has to be provided. This also makes it possible to use high-performance vehicle cameras which nowadays have resolutions of up to 20 megapixels, in which case on the one hand the first image area corresponding to the respective current focus area is provided with a high resolution using the resolution of such high-performance vehicle cameras, as a result of which, for example, maximum detection of objects is possible, and on the other hand a lower resolution is used in the second image area corresponding to the remaining area in order to limit the image information of the environment image as a whole. As a result, an influence of a high or increased resolution of the camera image on the processing speed for a computer vision algorithm and/or deep neural network learning methods (deep learning), for example by means of a convolutional neural network (CNN), can also be compensated for without dispensing with their advantages, at least in the first image area corresponding to the current focus area. These advantages can become particularly apparent if the resolution for the environment image is additionally reduced, either for the first image area and/or for the second image area.

The environment image is used for further processing. It is based on the camera image and can contain parts of it, for example in the first or second image area, or the first and/or second image area of the environment image is/are formed on the basis of the camera image, for example as part of data compression, a reduction in the resolution or the like.

The camera image is provided by the vehicle camera. It can have fundamentally any resolution in accordance with an optical sensor of the vehicle camera. The camera image can contain color information, for example in RGB format, or only brightness information as a black-and-white image.

The vehicle camera can be any camera for mounting on a vehicle. Wide-angle cameras or fish-eye cameras are common in this field. Such vehicle cameras can capture camera image areas with angular ranges of more than 160° up to 180° and sometimes even more, with the result that the environment of the vehicle can be captured very comprehensively using a few cameras. Especially when using fish-eye cameras, distortions can occur that make it difficult to process the image. In particular, there is distortion in vertical lines and nearby objects are enlarged. Accordingly, the vehicle cameras or the image units having such vehicle cameras can carry out corrections, so that, for example, a computer vision algorithm can easily evaluate the corrected camera image. The vehicle cameras can be designed, for example, as a front camera, a rear camera, a right-hand side camera or a left-hand side camera and can be arranged accordingly on the vehicle.

Four or more vehicle cameras which make it possible to monitor an angular range of 360° around the vehicle are often used in a vehicle for complete monitoring of the environment. Correspondingly, for example, a front camera, a rear camera, a right-hand side camera and a left-hand side camera can be used together.

The position of the vehicle camera on the vehicle makes it possible to set the vehicle camera in relation to the at least one motion parameter. For example, a different focus area is respectively currently relevant for a side camera when driving forward and when reversing the vehicle. In principle, the position of the vehicle camera can only be determined once, since the position does not change during operation.

The camera resolution depends on the vehicle camera. It is not necessary to use a specific resolution.

The further processing, in particular by a driving assistance system of the vehicle, relates, for example, to a computer vision algorithm and/or deep neural network learning methods (deep learning), for example by means of a convolutional neural network (CNN). This processing takes place in particular on specially embedded platforms or on so-called digital signal processors (DSP) with a limited computing capacity.

The image unit can have a plurality of vehicle cameras, with the control unit receiving the camera images from the plurality of vehicle cameras via the data bus and providing a corresponding environment image for each of the vehicle cameras. In principle, the image unit can also have a plurality of control units which each individually or jointly carry out the method for each of the camera images from one or more vehicle cameras.

In particular, the steps for capturing at least one current motion parameter of the vehicle, for determining a current focus area and for transferring pixels of the camera image into the environment image are carried out in a loop in order to continuously provide environment images for further processing.

In an advantageous configuration of the invention, capturing at least one current motion parameter of the vehicle comprises capturing a current direction of motion of the vehicle. The direction of motion can be captured, for example, by means of odometry information relating to the vehicle. For example, it is possible to capture a steering angle of the vehicle that indicates a direction of motion of the vehicle. For example, steering angle sensors are known for this purpose. Alternatively or additionally, the direction of motion of the vehicle can be captured on the basis of position information from a global navigation satellite system (GNSS). Acceleration sensors or other sensors are also known for capturing a direction of motion or a change in the direction of motion.

Based on the direction of motion, the following options for determining the respective current focus area arise, for example, as explained below. In principle, of course, other rules for determining the respective current focus area can be used. For the front camera, for example, when driving forward (straight ahead) and reversing (straight ahead), the current focus area can be in a center of the camera image. The current focus area can be accordingly set to the right of this when driving to the right, and to the left of this when driving to the left. Driving to the right or left also includes in this case a forward or backward directional component, i.e. the motion speed of the vehicle is greater than or less than zero. The current focus area when driving to the right or left can be independent of the motion speed of the vehicle. The same applies to the rear camera, with the difference that, when driving to the right, the current focus area is set to the left of the center and, when driving to the left, the current focus area is set to the right of the center. For example, for the right-hand side camera, the current focus area can be set to the left of the center when driving forward (straight ahead), whereas the current focus area is set to the right of the center when reversing (straight ahead). When driving to the right or left, the current focus area can be set in the center of the camera image. Similarly, for the left-hand side camera, the current focus area is set to the right of the center when driving forward (straight ahead), whereas it is set to the left of the center when reversing (straight ahead). When driving to the right or left, the current focus area can be set in the center of the camera image.

In an advantageous configuration of the invention, capturing at least one current motion parameter of the vehicle comprises capturing a current motion speed of the vehicle. Based on this, the current focus area can be adapted, especially for vehicle cameras looking forward or backward, in order to be able to reliably capture the environment. For example, when the vehicle is traveling at low speed, the current focus area can be set with a different size or a different resolution than when the vehicle is traveling at high speed. At low speed, good capture of the entire environment of the vehicle is particularly advantageous, whereas at high speeds it is particularly advantageous to be able to reliably capture and, if appropriate, recognize objects in the direction of motion of the vehicle, even at great distances. As a result, a vehicle control system can be adapted to such objects in good time even at high speeds, which makes it possible for the vehicle to move uniformly. The motion speed of the vehicle can be captured, for example, by means of odometry information relating to the vehicle. For example, a wheel revolution of a wheel of the vehicle can be captured, from which a motion speed of the vehicle can be derived. Alternatively or additionally, the direction of motion of the vehicle can be captured on the basis of position information from a global navigation satellite system (GNSS). Acceleration sensors or other sensors are also known for capturing a motion speed or a change in the motion speed.

In an advantageous configuration of the invention, capturing at least one current motion parameter of the vehicle comprises capturing a change in the position of objects between camera images or environment images that were provided with a time delay, and determining the current direction of motion and/or the current motion speed of the vehicle on the basis of the captured change in the position of the objects. The provision of the camera images or environment images with a time delay relates to two or more of the images that are provided from a sequence of images. The images may be immediately consecutive images from the sequence, for example consecutive images in a video sequence, or may skip images in the sequence. A motion of objects in the images can be captured on the basis of the temporally offset images, from which in turn the at least one current motion parameter of the vehicle can be captured. The capture of the at least one current motion parameter of the vehicle can be determined on the basis of an optical flow, for example.

In an advantageous configuration of the invention, determining a current focus area within the camera image on the basis of the position of the vehicle camera on the vehicle and the at least one current motion parameter comprises selecting the current focus area from a plurality of predefined focus areas. The restriction to a plurality of predefined focus areas makes it easier to carry out the method, with the result that it can be carried out easily and efficiently. The predefined focus areas comprise, in particular, focus areas that are each directed toward a center and edge areas of the camera image. This can relate to a horizontal direction and/or a vertical direction in the camera image. The current focus area can be selected from the predefined focus areas quickly and efficiently.

In an advantageous configuration of the invention, determining a current focus area within the camera image on the basis of the position of the vehicle camera on the vehicle and the at least one current motion parameter comprises determining a horizontal position of the current focus area based on the camera image, in particular as a right-hand focus area, a middle focus area or a left-hand focus area. The horizontal position is a position in a horizontal plane. When driving a vehicle, the horizontal plane is usually of particular importance, since objects in such a plane can usually interact or even collide with the vehicle. Preferably, the focus areas comprise a line in the vertical direction, which is often also referred to as a “horizon”, i.e. a line which separates the earth from the sky. This vertical orientation is particularly suitable for being able to detect relevant objects and/or driving situations.

In an advantageous configuration of the invention, determining a current focus area within the camera image on the basis of the position of the vehicle camera on the vehicle and the at least one current motion parameter comprises determining a size of the current focus area within the camera image. For example, the size of the current focus area can be adapted depending on the motion speed. The size of the current focus area can also depend on its horizontal position in relation to the camera image, i.e. a right-hand focus area can have a different size than a middle focus area. For example, in the case of a side camera, a right-hand or left-hand current focus area can be selected to be small, since the side camera can only provide a relatively small amount of relevant information with regard to the corresponding direction of travel. In contrast, when turning, a middle current focus area can be selected to be larger, since the side camera can provide a large amount of relevant information with regard to relevant objects in the area of the vehicle when turning.

In an advantageous configuration of the invention, determining a current focus area within the camera image on the basis of the position of the vehicle camera on the vehicle and the at least one motion parameter comprises determining a shape of the current focus area within the camera image. In principle, the shape of the current focus area can be selected arbitrarily. In practice, for example, an oval shape as well as a rectangular shape has proven itself, it being possible for the rectangular shape as well as the oval shape to be selected, for example, in accordance with an aspect ratio of the camera image. The shape of the current focus area can also be currently determined for the focus area in each case.

In an advantageous configuration of the invention, transferring pixels of the camera image into the environment image comprises transferring the pixels with a continuous transition between the first and the second image area. A continuous transition means that there is no abrupt change in the resolution of the environment image between the first and the second image area. The resolution is therefore adapted via an adaptation area in which the resolution changes from the first resolution to the second resolution. This facilitates the use of the environment image for further processing, for example in order to detect and classify objects in the environment image using neural networks. In principle, the adaptation area can be part of the first image area, the second image area, or both image areas.

In an advantageous configuration of the invention, transferring pixels of the camera image into the environment image, wherein pixels from the current focus area are transferred with a first resolution into a first image area of the environment image that corresponds to the current focus area, and pixels of the camera image from a remaining area that is not in the current focus area are transferred with a second resolution into a second image area of the environment image corresponding thereto, wherein the second resolution is lower than the first resolution, comprises transferring the pixels in a vertical direction with a lower resolution than in a horizontal direction. There is therefore a non-linear transfer of the pixels of the camera image into the environment image. The non-linear transfer of the pixels of the camera image into the environment image can comprise, for example, non-linear compression or non-linear downscaling in relation to the two image directions, i.e. the vertical direction and the horizontal direction. In particular, a non-linear resolution can be selected in the vertical direction, with a higher resolution being used in a middle area, in which objects that are typically relevant to the vehicle are located, than in edge areas. In this way, for example, an additional focus in the environment image can be placed on image areas that typically contain a high content of relevant information, for example in the area of a “horizon”.

In an advantageous configuration of the invention, transferring pixels of the camera image into the environment image comprises reducing the resolution from the remaining area of the camera image, which is not in the current focus area, to the second image area of the environment image corresponding thereto. Reducing the resolution from the remaining area of the camera image, which is not in the current focus area, to the second image area of the environment image corresponding thereto results in the environment image being provided with a reduced number of pixels compared to the camera image. Providing the environment image with a reduced resolution makes it possible for the environment image to be subsequently processed with little effort, i.e. few processing resources, with the result that the images can also be processed easily in embedded systems such as in driving assistance systems of vehicles. The reduced resolution can be provided in different ways in this case, for example by performing data compression when transferring the pixels of the camera image from the remaining area, which is not in the current focus area, into the second image area of the environment image corresponding thereto. Simple compression can be achieved by combining a plurality of pixels of the camera image into one pixel of the environment image. In this case, a plurality of pixels can be combined in any way, it not only being possible to use multiples of one pixel. For example, three pixels of the camera image can also be used in one image direction to determine two pixels of the environment image. As an alternative to combining pixels, individual pixels of the camera image can also be adopted as pixels of the environment image. Pixels that are not adopted are ignored in this case. Preferably, when reducing the resolution from the remaining area of the camera image, which is not in the current focus area, to the second image area of the environment image corresponding thereto, the focus area is adopted without changing the resolution. As a result, image information relating to the focus area that is provided by the vehicle camera can be fully used, while at the same time the environment image can be processed efficiently and quickly overall.

In an advantageous configuration of the invention, transferring pixels of the camera image into the environment image comprises reducing the resolution from the current focus area of the camera image to the first image area of the environment image that corresponds to the current focus area. In principle, the same explanations apply as in relation to reducing the resolution from the remaining area of the camera image, which is not in the current focus area, to the second image area of the environment image corresponding thereto. However, the two reductions in the resolution are in principle independent of one another. In order to be able to perform improved detection of detail in the current focus area, the second resolution must be lower than the first resolution. Thus, for example, data compression is carried out when transferring the pixels of the camera image into the first and second image areas of the environment image, with the compression being lower in the focus area. As a result, compared to merely reducing the resolution from the remaining area of the camera image, which is not in the current focus area, to the second image area of the environment image corresponding thereto, the environment image can be provided overall with a further reduced amount of data, as a result of which the environment image can be processed particularly quickly.

In an advantageous configuration of the invention, transferring pixels of the camera image into the environment image comprises increasing the resolution from the current focus area of the camera image to the first image area of the environment image that corresponds to the current focus area. It is therefore also possible to provide an environment image which, for example, has the same number of pixels as the camera image, but with the resolution being increased in the focus area compared to the camera image. Increasing the resolution from the current focus area of the camera image to the first image area of the environment image that corresponds to the current focus area can also be combined with reducing the resolution from the remaining area of the camera image, which is not in the current focus area, to the second image area of the environment image corresponding thereto. On the one hand, the image data of the camera image are reduced overall and, on the other hand, the focus area is enlarged, with the result that distant objects in particular can be well perceived. In principle, it is preferable to use a vehicle camera with a higher resolution, in which case the resolution then does not have to be increased from the current focus area of the camera image to the first image area of the environment image that corresponds to the current focus area, and then, if necessary, to reduce the resolution from the remaining area of the camera image, which is not in the current focus area, to the second image area of the environment image corresponding thereto, since this requires fewer resources overall. Various mathematical methods are known for increasing the resolution, in order to increase the resolution from the current focus area to the first image area of the environment image that corresponds to the current focus area.

In an advantageous configuration of the invention, transferring pixels of the camera image into the environment image comprises transferring the pixels of the camera image into the environment image based on a transfer rule in a look-up table for differently determined focus areas. The look-up table can contain an assignment of pixels of the camera image to the environment image in order to provide the environment image in a particularly simple manner. The use of the look-up table enables a very efficient method for providing the environment image, in particular for use in control units of vehicles. The look-up table can thus be designed as a two-dimensional matrix which assigns a pixel of the camera image to each pixel of the environment image that has a lower resolution than the camera image. With a resolution of one megapixel and compression of 2.5, such a two-dimensional matrix can have approximately 1500 entries, for example, while a corresponding calculation requires approximately 400 000 calculation steps. For example, using the look-up table makes it possible to easily change the current focus area by merely changing a pointer to a position in the look-up table, and thus a different two-dimensional matrix can be selected. Correspondingly predefined look-up tables are predefined for each focus area, with the result that, depending on a number of possible focus areas, a corresponding number of two-dimensional matrices is required in order to be able to provide the environment image in each case. The matrices can be predefined such that they do not have to be created by the image unit itself.

The invention is explained in more detail below with reference to the attached drawing and on the basis of preferred embodiments. The features shown may each represent an aspect of the invention both individually and in combination. Features of different exemplary embodiments may be transferred from one exemplary embodiment to another.

In the figures:

FIG. 1 shows a schematic view of an original camera image in comparison with an environment image with linear downscaling and non-linear downscaling from the prior art,

FIG. 2 shows a vehicle having an image unit with four vehicle cameras and a control unit connected thereto via a data bus according to a first preferred embodiment,

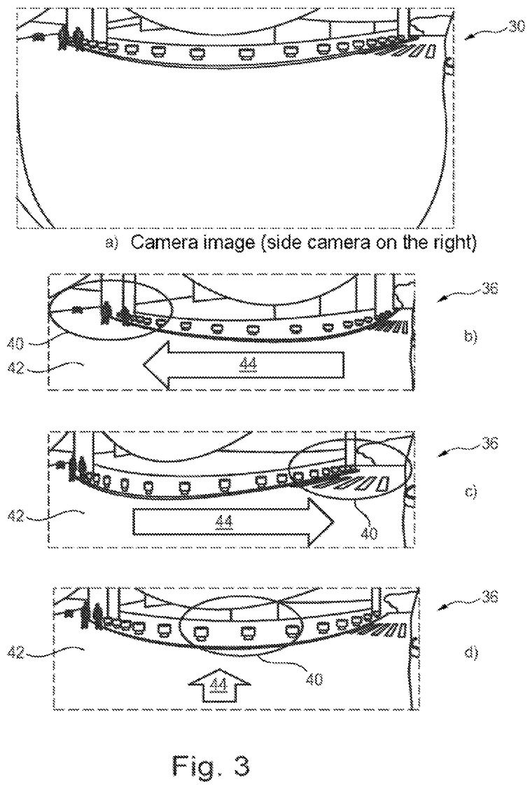

FIG. 3 shows an exemplary camera image from a side camera of the vehicle from FIG. 2 with three different environment images based on three differently selected current focus areas in accordance with the first embodiment,

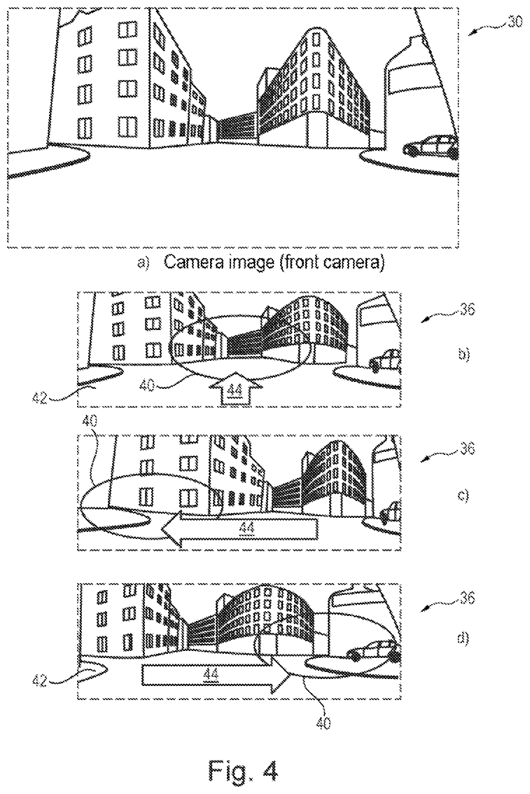

FIG. 4 shows an exemplary camera image from a front camera of the vehicle from FIG. 2 with three different environment images based on three differently selected current focus areas in accordance with the first embodiment,

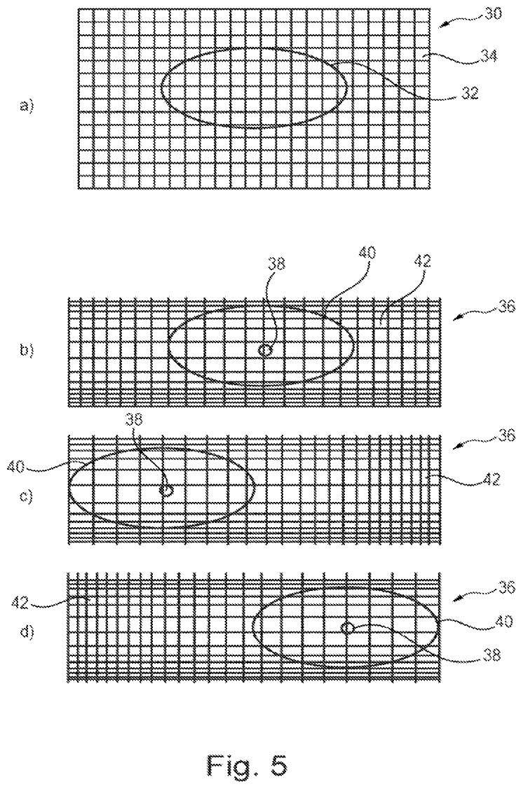

FIG. 5 shows an exemplary generic camera image from a vehicle camera of the vehicle from FIG. 2 with a grid, which was transferred into three different environment images based on three differently selected current focus areas, in accordance with the first embodiment,

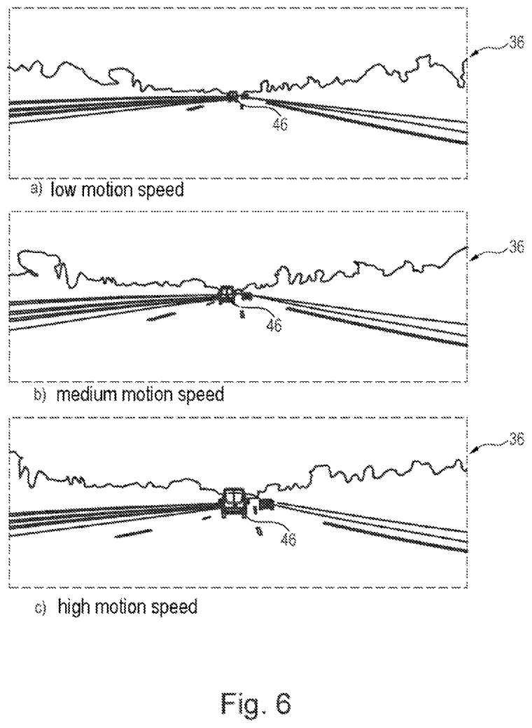

FIG. 6 shows an exemplary illustration of three different environment images, which were provided starting from a camera image from a front camera of the vehicle from FIG. 2 based on three differently selected current focus areas, in accordance with the first embodiment,

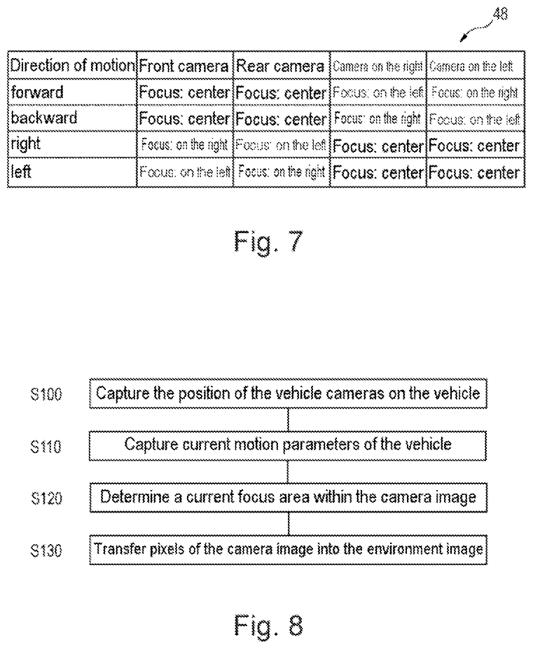

FIG. 7 shows a table with different vehicle cameras plotted against possible directions of motion of the vehicle, with a position of the current focus area for combinations of the vehicle camera and the direction of motion of the vehicle being indicated in each case, and

FIG. 8 shows a flowchart of a method for providing an environment image on the basis of a camera image from a vehicle camera of the vehicle from FIG. 2 for monitoring an environment of the vehicle, the camera image having a camera image area with a camera resolution, for further processing, in particular by a driving assistance system of the vehicle, according to the first embodiment.

FIG. 1 shows a vehicle 10 having an image unit 12 according to a first preferred embodiment.

The image unit 12 comprises a plurality of vehicle cameras 14, 16, 18, 20 for providing in each case a camera image 30 having a camera image area and a camera resolution, and a control unit 22 which is connected to the vehicle cameras 14, 16, 18, 20 via a data bus 24. The control unit 22 receives the camera images 30 from the various vehicle cameras 14, 16, 18, 20 via the data bus 24. The camera images 30 are provided by the vehicle cameras 14, 16, 18, 20 in this exemplary embodiment, each with an identical camera resolution. In this exemplary embodiment, the camera images 30 each contain color information in the RGB format.

The vehicle cameras 14, 16, 18, 20 are realized on the vehicle 10 as a front camera 14 at a position on the front of the vehicle 10, as a rear camera 16 at a position on the rear of the vehicle 10, as a right-hand side camera 18 at a position on a right-hand side of the vehicle 10 and as a left-hand side camera 20 at a position on a left-hand side of the vehicle 10, relative to a forward direction of travel 26 of the vehicle 10.

In this exemplary embodiment, the vehicle cameras 14, 16, 18, 20 are designed as wide-angle cameras or, in particular, as fish-eye cameras and each have a camera image area with an angular range of more than 160° up to 180° as the camera image area. When using fish-eye cameras as vehicle cameras 14, 16, 18, 20, corrections are carried out in the image unit 12 in order to compensate for distortions in the camera images 30 based on the special optical properties of the fish-eye cameras. The four vehicle cameras 14, 16, 18, 20 together make it possible to completely monitor an environment 28 around the vehicle 10 with an angular range of 360°.

The image unit 12 is designed to carry out the method, described in detail below, for providing an environment image 36 on the basis of a respective camera image 30 for the vehicle cameras 14, 16, 18, 20. In this exemplary embodiment, the control unit 22 carries out parallel processing of the camera images 30 provided by the vehicle cameras 14, 16, 18, 20 in order to provide the respective environment images 36.

The environment images 36 are used by a driving assistance system (not illustrated here) of the vehicle 10 to monitor the environment 28 of the vehicle 10 for further processing. The driving assistance system comprises the image unit 12 and performs a driving assistance function based on the monitoring of the environment 28 of the vehicle 10. The further processing relates, for example, to a computer vision algorithm and/or deep neural network learning methods (deep learning), for example by means of a convolutional neural network (CNN). This processing takes place in particular on specially embedded platforms or on so-called digital signal processors (DSP) with a limited computing capacity within the vehicle 10.

The method for providing an environment image 36 on the basis of a camera image 30 from the respective vehicle cameras 14, 16, 18, 20 of the vehicle 10, which is illustrated as a flowchart in FIG. 8, is described below. The method is carried out using the image unit 12 of the vehicle 10 from FIG. 2. The method is carried out individually for each of the vehicle cameras 14, 16, 18, 20 of the vehicle 10, i.e. before a possible fusion of sensor data from the vehicle cameras 14, 16, 18, 20 of the vehicle 10. The method is carried out in order to provide the environment images 36 of the four vehicle cameras 14, 16, 18, 20 for monitoring an environment 28 of the vehicle 10, for further processing, in particular by the driving assistance system of the vehicle 10.

The method begins with step S100 which comprises determining a respective position of the various vehicle cameras 14, 16, 18, 20 on the vehicle 10. Accordingly, a position on the front of the vehicle 10 is determined for the front camera 14, a position on the rear of the vehicle 10 is determined for the rear camera 16, a position on a right-hand side of the vehicle 10 is determined for the right-hand side camera 18, and a position on a left-hand side of the vehicle 10 is determined for the left-hand side camera 20.

Step S110 relates to capturing current motion parameters 44 of the vehicle 10. In this exemplary embodiment, the motion parameters 44 comprise a current direction of motion 44 of the vehicle 10 and a motion speed of the vehicle 10. In the first exemplary embodiment, the motion parameters 44 will be captured by means of odometry information relating to the vehicle 10. For this purpose, a steering angle of the vehicle 10 is captured using a steering angle sensor and a wheel revolution of a wheel of the vehicle 10 is captured using a corresponding revolution sensor.

In an alternative exemplary embodiment, the motion parameters 44 are captured on the basis of position information from a global navigation satellite system (GNSS).

Step S120 relates to determining a current focus area 32 within the camera image 30 on the basis of the position of the vehicle camera 14, 16, 18, 20 on the vehicle 20 and the current motion parameters. For this purpose, the current focus area 32 is selected from a plurality of predefined focus areas 32 on the basis of the previously captured motion parameters 44. The predefined focus areas 32 have different positions in a horizontal direction and respectively comprise a right-hand focus area 32 on a right-hand edge of the camera image 30, a middle focus area 32 at a center of the camera image 30, or a left-hand focus area 32 on a left-hand edge of the camera image 30. The predefined focus areas 32 each have a fixed, identical size and a likewise identical, oval shape. The predefined focus areas 32 are also arranged in the vertical direction on a line which is often also referred to as a “horizon”, i.e. a line which separates the earth from the sky.

This is illustrated generically in FIG. 5. FIG. 5a) shows an exemplary camera image 30 with a uniform grid pattern. The first image areas 40 each selected as current focus areas 32 are illustrated in FIGS. 5b), 5c) and 5d) with their respective focus point 38 for the provided environment image 36 in different positions in the horizontal direction, wherein FIG. 5b) shows a first image area 40 corresponding to a middle focus area 32 in a center of the environment image 36, FIG. 5c) shows a first image area 40 corresponding to a left-hand focus area 32 on a left-hand edge of the environment image 36, and FIG. 5d) shows a first image area 40 corresponding to a right-hand focus area 32 on a right-hand edge of the environment image 36. The first image areas 40 each have a fixed, identical size and a likewise identical, oval shape in accordance with the predefined focus areas 32. The first image areas 40 are also arranged on a line in the vertical direction in accordance with the predefined focus areas 32.

The current focus area 32 is determined in this case in different ways for the different vehicle cameras 14, 16, 18, 20, as illustrated by way of example on the basis of the direction of motion 44 in the table in FIG. 7. A uniform motion speed is assumed in the table, and so the motion speed is disregarded for differentiation. In principle, the motion speed can be disregarded as a motion parameter, for example below a limit speed, with the result that the current focus area 32, for example in city traffic with a motion speed of, for example, up to 50 km/h or up to 60 km/h, is determined only on the basis of the direction of motion 44 and the position of the respective vehicle camera 14, 16, 18, 20 on the vehicle 10.

This results, for example for the front camera 14, as is explained with additional reference to FIG. 4, in the middle focus area 32 being determined as the current focus area 32 when driving forward (straight ahead) and reversing (straight ahead). The right-hand focus area 32 is determined as the current focus area 32 when driving to the right, whereas the left-hand focus area 32 is determined as the current focus area 32 when driving to the left. Driving to the right or left also includes in this case a forward or backward directional component, i.e. the motion speed of the vehicle 10 is greater than or less than zero. The selection of the current focus area 32 when driving to the right or left is independent here of the forward or backward directional component.

Furthermore, for the rear camera 16, the middle focus area 32 is determined as the current focus area 32 when driving forward (straight ahead) and reversing (straight ahead). The left-hand focus area 32 is determined as the current focus area 32 when driving to the right, whereas the right-hand focus area 32 is determined as the current focus area 32 when driving to the left. Here, too, driving to the right or left includes a forward or backward directional component, i.e. the motion speed of the vehicle 10 is greater than or less than zero. The selection of the current focus area 32 when driving to the right or left is independent here of the forward or backward directional component.

In addition, for the right-hand side camera 18, as is explained with additional reference to FIG. 3, the left-hand focus area 32 is determined as the current focus area 32 when driving forward (straight ahead). When reversing (straight ahead), the right-hand focus area 32 is determined as the current focus area 32. When driving to the right, the middle focus area 32 is determined as the current focus area 32. The middle focus area 32 is also determined as the current focus area 32 for driving to the left.

Finally, for the left-hand side camera 20, as explained with additional reference to FIG. 3, the right-hand focus area 32 is determined as the current focus area 32 when driving forward (straight ahead). When reversing (straight ahead), the left-hand focus area 32 is determined as the current focus area 32. When driving to the right, the middle focus area 32 is determined as the current focus area 32. The middle focus area 32 is also determined as the current focus area 32 for driving to the left.

It also applies to the two side cameras 18, 20 that driving to the right or left includes a forward or backward directional component, i.e. the motion speed of the vehicle 10 is greater than or less than zero. The selection of the current focus area 32 when driving to the right or left is independent here of the forward or backward directional component.

Additionally or alternatively, the current focus area 32 is adapted based on the motion speed, for example above a limit speed. As illustrated in FIG. 6 for the respective environment images 36, when driving at different motion speeds, the current focus area 32 is adapted to the respective current motion speed. FIG. 6a), which relates to driving the vehicle 10 at a low motion speed, thus illustrates the first image area 40 corresponding to the current focus area 32 with a low resolution, i.e. with a high level of compression. The resolution of the first image area 40 is only slightly greater than the resolution of the second image area 42 that corresponds to the remaining area 34. When driving the vehicle 10 at a medium motion speed, which is illustrated in FIG. 6b), the first image area 40 corresponding to the current focus area 32 is illustrated with a medium resolution, i.e. with an increased resolution compared to driving at a low motion speed. The current focus area 32 was thus transferred to the first image area 40 with a lower degree of compression than when driving at a low speed. The resolution of the first image area 40 is thus increased compared to the example from FIG. 6a). Thus, the resolution of the first image area 40 in FIG. 6b) is increased compared to the resolution of the second image area 42 corresponding to the remaining area 34. An object 46 shown in the environment image 36, here a vehicle driving in front, is visibly enlarged compared to the illustration in FIG. 6a). When driving the vehicle 10 at a high motion speed, which is illustrated in FIG. 6c), the first image area 40 corresponding to the current focus area 32 is illustrated with a high resolution, i.e. with a resolution that has been increased further compared to driving at a medium motion speed. The current focus area 32 was thus transferred to the first image area 40 with a lower degree of compression than when driving at a medium speed. The resolution of the first image area 40 is thus increased further compared to the example from FIG. 6b). Thus, the resolution of the first image area 40 in FIG. 6c) has also been increased further compared to the resolution of the second image area 42 corresponding to the remaining area 34. An object 46 shown in the environment image 36, here a vehicle driving in front, is visibly enlarged further compared to the illustration in FIG. 6b). As a result, objects 46 in the far range of the vehicle 10 within the current focus area 32 of the camera image 30 can already be captured at a great distance. This takes account of different maneuvering capabilities of the vehicle 10 at a high motion speed, in which case only a small change in the direction of motion 44 is possible, and at a low motion speed, in which case a rapid change in the direction of motion 44 is possible. The resolution of the second image area 42 is selected to be identical in each of the environment images 36 illustrated in FIG. 6, with the result that the environment images 36 each have the same image size.

Step S130 relates to transferring pixels of the camera image 30 into the environment image 36), wherein pixels from the current focus area 32 are transferred with a first resolution into a first image area 40 of the environment image 36 that corresponds to the current focus area 32, and pixels of the camera image 30 from a remaining area 34 that is not in the current focus area 32 are transferred with a second resolution into a second image area 42 of the environment image 36 corresponding thereto.

As explained above in relation to determining the current focus area 32, the second resolution is in each case lower than the first resolution. Within this specification, the resolution of the first or second image area 40, 42 can be different, depending on a respectively selected way in which the respective environment image 36 is provided.

For the current focus area 32 selected from the predefined focus areas 32, a corresponding entry in a look-up table 48 for differently determined focus areas 32 is selected. The look-up table 48 contains an assignment of pixels of the camera image 30 to the environment image 36 based on the various possible focus areas 32. In this case, a transfer rule which is used to transfer the pixels of the camera image 30 into the environment image 36 is stored in the look-up table 48 for each possible focus area 32. The look-up table 48 thus comprises a plurality of two-dimensional matrices which each assign a pixel of the camera image 30 to each pixel of the environment image 30. When changing the current focus area 32, a pointer to a position of the corresponding matrix in the look-up table 48 is changed.

As can be seen in the generic illustration in FIG. 5, pixels of the camera image 30 are transferred into the respective environment image 36 with a continuous transition between the first and the second image area 40, 42, i.e. without an abrupt change in the resolution of the environment image 36 between the first and the second image area 40, 42. The resolution is therefore adapted via an adaptation area in which the resolution changes from the first resolution to the second resolution. The adaptation area, which is not explicitly illustrated in FIG. 5, is part of the second image area 42 here.

In addition, it can be seen in FIG. 5 that the pixels are transferred from the camera image 30 into the respective environment image 36 in the vertical direction with a lower resolution than in a horizontal direction. There is therefore a non-linear transfer of the pixels of the camera image 30 into the respective environment image 36. In addition, a non-linear resolution is selected in the vertical direction, with a higher resolution being used in a middle area, in which the current focus area 32 can be determined, than in edge areas.

Overall, the environment image 36 is provided in each case with a reduced resolution compared to the camera image 30, in which case the second image area 42 corresponding to the remaining area 34 of the camera image 30 has a lower resolution than the first image area 40 corresponding to the current focus area 32.

Steps S110 to S130 described above are carried out in a loop in the present case in order to continuously provide environment images 36 for further processing.

### LIST OF REFERENCE SIGNS

10 Vehicle
12 Image unit
14 Vehicle camera, front camera
16 Vehicle camera, rear camera
18 Vehicle camera, side camera on the right
20 Vehicle camera, side camera on the left
22 Control unit
24 Data bus
26 Forward direction of travel
28 Environment
30 Camera image
32 Focus area
34 Remaining area
36 Environment image
38 Focus point
40 First image area
42 Second image area
44 Direction of motion, motion parameters
46 Object
48 Look-up table

1. A method for providing an environment image on the basis of a camera image from a vehicle camera of a vehicle for monitoring an environment of the vehicle, the camera image having a camera image area with a camera resolution, for further processing, by a driving assistance system of the vehicle, comprising: determining a position of the vehicle camera on the vehicle, capturing at least one current motion parameter of the vehicle,
determining a current focus area within the camera image on the basis of the position of the vehicle camera on the vehicle and the at least one current motion parameter, and
transferring pixels of the camera image into the environment image, wherein pixels from the current focus area are transferred with a first resolution into a first image area of the environment image that corresponds to the current focus area, and pixels of the camera image from a remaining area that is not in the current focus area are transferred with a second resolution into a second image area of the environment image corresponding thereto, wherein the second resolution is lower than the first resolution.

2. The method as claimed in claim 1, wherein capturing at least one current motion parameter of the vehicle comprises capturing a direction of motion of the vehicle.

3. The method as claimed in claim 1, wherein capturing at least one current motion parameter of the vehicle comprises capturing a current motion speed of the vehicle.

4. The method as claimed in claim 2, wherein capturing at least one current motion parameter of the vehicle comprises capturing a change in the position of objects between camera images or environment images that were provided with a time delay, and determining the current direction of motion and/or the current motion speed of the vehicle on the basis of the captured change in the position of the objects.

5. The method as claimed in claim 1, wherein determining a current focus area within the camera image on the basis of the position of the vehicle camera on the vehicle and the at least one current motion parameter comprises selecting the current focus area from a plurality of predefined focus areas.

6. The method as claimed in claim 1, wherein in that determining a current focus area within the camera image on the basis of the position of the vehicle camera on the vehicle and the at least one current motion parameter comprises determining a horizontal position of the current focus area based on the camera image as a right-hand focus area, a middle focus area or a left-hand focus area.

7. The method as claimed in claim 1, wherein determining a current focus area within the camera image on the basis of the position of the vehicle camera on the vehicle and the at least one current motion parameter comprises determining a size of the current focus area within the camera image.

8. The method as claimed in claim 1, wherein transferring pixels of the camera image into the environment image comprises transferring the pixels with a continuous transition between the first and the second image area.

9. The method as claimed in claim 1, wherein transferring pixels of the camera image into the environment image, wherein pixels from the current focus area are transferred with a first resolution into a first image area of the environment image that corresponds to the current focus area, and pixels of the camera image from a remaining area that is not in the current focus area are transferred with a second resolution into a second image area of the environment image corresponding thereto, wherein the second resolution is lower than the first resolution, comprises transferring the pixels in a vertical direction with a lower resolution than in a horizontal direction.

10. The method as claimed in claim 1, wherein transferring pixels of the camera image into the environment image comprises reducing the resolution from the remaining area of the camera image, which is not in the current focus area, to the second image area of the environment image corresponding thereto.

11. The method as claimed in claim 9, wherein transferring pixels of the camera image into the environment image comprises reducing the resolution from the current focus area of the camera image to the first image area of the environment image that corresponds to the current focus area.

12. The method as claimed in claim 1, transferring pixels of the camera image into the environment image comprises increasing the resolution from the current focus area of the camera image to the first image area of the environment image that corresponds to the current focus area.

13. The method as claimed in claim 1, wherein transferring pixels of the camera image into the environment image comprises transferring the pixels of the camera image into the environment image based on a transfer rule in a look-up table for differently determined focus areas.

14. An image unit for providing an environment image on the basis of a camera image from a vehicle camera of a vehicle for monitoring an environment of the vehicle, for further processing, by a driving assistance system of the vehicle, comprising:
at least one vehicle camera for providing the camera image having a camera image area and a camera resolution; and
a control unit which is connected to the at least one vehicle camera via a data bus and receives the respective camera image via the data bus,
wherein the image unit is configured to carry out the method for providing an environment image as claimed in claim 1 for the at least one vehicle camera.

15. A driving assistance system for a vehicle for providing at least one driving assistance function based on monitoring an environment of the vehicle, comprising at least one image unit as claimed in claim 14.
